(19) United States
(12) Patent Application Publication
(10) Pub. No.: US 2022/0176386 A1
(43) Pub. Date: Jun. 9, 2022

(54) COLLECTOR COMPOSITIONS CONTAINING A N-ACYLATED AMINO ACID AND PROCESS TO TREAT NON-SULFIDIC ORES

(71) Applicant: NOURYON CHEMICALS INTERNATIONAL B.V., ARNHEM (NL)

(72) Inventors: Natalija SMOLKO SCHWARZMAYR, Haelteby (SE); Mikhail GOLETS, Uddevalla (SE)

(73) Assignee: NOURYON CHEMICALS INTERNATIONAL B.V., ARNHEM (NL)

(21) Appl. No.: 17/594,490

(22) PCT Filed: Apr. 17, 2020
(86) PCT No.: PCT/EP2020/060896

§ 371 Date: Oct. 19, 2021

(30) Foreign Application Priority Data
Apr. 19, 2019 (EP) 19170362.8

(51) Int. Cl. B03D 1/01; B03D 1/02

(52) U.S. Cl. CPC B03D 1/01; B03D 2201/02; B03D 1/021

(57) ABSTRACT

A collector composition suitable for treating non-sulfidic ores comprises
(i) from about 1 to 50 wt % of an N acylated amino acid or salt thereof of the structural formula R1-CO—NX—CYH—(CH2)m-COOM
(ii) from about 10 to 80 wt % of an alcohol alkoxylate of the formula R2-(AO)n wherein R1 is an alkyl or alkenyl group of 7 to 21 carbon atoms, X is a hydrogen atom or methyl group, Y is a hydrogen atom, a C1-C4 alkyl, a C1-C4 hydroxylalkyl, a C1-C4 carboxyalkyl, or a C1-C4 aminoalkyl group, m is 0 or 1, M is a proton, an alkalimetal cation, or a quaternary ammonium cation, R2 is an alkyl group of 6 to 20 carbon atoms, each AO is independently ethyleneoxy or propyleneoxy, provided that at least part of AO is ethyleneoxy, and n is higher than 2 and up to 25, the wt % based on the total weight of the composition.

### CROSS-REFERENCE TO RELATED APPLICATION

This application is a U.S. National-Stage entry under 35 U.S.C. § 371 based on International Application No. PCT/EP2020/060896 filed Apr. 17, 2020 which was published under PCT Article 21(2) and which claims priority to European Application No. 19170362.8, filed Apr. 19, 2019, which are all hereby incorporated in their entirety by reference.

### TECHNICAL FIELD

The present disclosure relates to improved collector compositions for treating non-sulfidic ores, such as phosphate or calcite ores, that contain a N-acylated amino acid and a non-ionic surfactant.

### BACKGROUND

Froth flotation is a physico-chemical process used to separate mineral particles considered economically valuable from those considered waste. It is based on the ability of air bubbles to attach onto those particles previously rendered hydrophobic. The particle-bubble combinations then rise to the froth phase from where it discharges the flotation cell whilst the hydrophilic particles remain in the flotation cell. Particle hydrophobicity is, in turn, induced by special chemicals called collectors. In direct flotation systems, it is the economically valuable minerals which are rendered hydrophobic by the action of the collector. Similarly, in reverse flotation systems, the collector renders hydrophobicity to those mineral particles considered waste. The efficiency of the separation process is quantified in terms of recovery and grade. Recovery refers to the percentage of valuable product contained in the ore that is removed into the concentrate stream after flotation. Grade refers to the percentage of the economically valuable product in the concentrate after flotation. A higher value of recovery or grade indicates a more advantageous flotation system. Usually for a collector to be of commercial interest in an application a minimum grade needs to be reached and for this minimum grade an as high as possible recovery. In collector compositions usually the secondary collector is primarily responsible for improvement of the recovery, efficiency, frothing characteristics, etc and the primary collector for the selectivity.

Good performance in a froth flotation process is achieved by a combination of, on the one hand, a good separation of the valuable mineral in a high amount from the gangue by using a selective collector and, on the other hand, the froth characteristics. The froth characteristics include both the amount and the stability of the froth. It is important in the flotation process that the froth collapses as soon as possible after it leaves the flotation cell for the next step in the beneficiation process. A too stable froth will cause both entrainment of particles and froth product pumping problems. Entrainment, especially on a large scale, will result in decreased selectivity (grade, recovery). Problems with froth product pumping will make a process of flotation technically impossible.

Naturally, a process to treat ores is also considered more favourable if less collector composition needs to be employed per tonne of ore.

Collector compositions containing N-acylated amino acids and their application in treating non sulfidic ores are known in the art.

T Karlkvist et al in “Flotation selectivity of novel alkyl dicarboxylate reagents for apatite-calcite separation” in Journal of Colloid and Interface Science 445 (2015), pp. 40-67 disclose the use of dodecyl N acylated-glycinate, -glutamate, -aspartate and -malonate in the flotation of apatite and calcite minerals.

J Beger et al in “Mehrfunktionele N-Tenside” in Tenside Detergents 23 (1986) 3 disclose several N acylated glycine, sarcosine, and alanine compounds and the use thereof in treating fluorite minerals.

WO 2016/155966 and WO 2014/040686 both disclose the use of N acyl sarcosinate in flotation of non-sulfidic minerals. In both documents the collector composition in addition contains fatty acid but the addition of any other surface active chemical is not disclosed.

FR 1,256,702 and CA 659535 disclose the froth flotation of minerals with collecting mixtures containing a sodium cocoyl sarcosinate and a further surface active agent. The further surface active agent in embodiments may be an alkylphenoxypolyglycol ether such as ethoxylated nonylphenol.

CN 1919466 discloses a collector for flotation of ilmenite wherein a sodium oleoyl sarcosinate in mixture with an emulsifier is employed, and the emulsifier may be an ethoxylated alkyl phenol such as Triton X-100.

Due to environmental concerns, the industry is looking to replace ethoxylated alkylphenols. This is not straightforward as ethoxylated alkylphenols have good collector properties that any compounds that replace them should also have or at least approach. At the same time, the industry is aiming to develop collector compositions that provide good grade of minerals in a flotation process and increased recovery.

DE 4105384 discloses the use of N-acyl oligoglycinates in the flotation of phosphate ores. CN108889453 discloses the use of palmitoyl glycine in the flotation of zinc-containing ores.

WO 2018/114741 discloses the use of N-acyl glycinate in flotation of non-sulfidic minerals in combination with a lowly ethoxylated fatty acid to improve selectivity.

WO 2015/000913 discloses the use of N-acyl glycinate in flotation of non-sulfidic minerals. The collector composition is disclosed to contain in addition to the glycinate, a fatty acid, lactic acid, and lactic acid esters of N acyl glycine and fatty acid.

It should be noted that WO 2015/000913 suggests the addition of several other flotation additives to the collector composition disclosed therein, amongst which also alcohol ethoxylates and propoxylates but is silent on which alcohol ethoxylates to employ, the amount in which to employ them and the effect that can be obtained by adding them to a collector composition other than that they are seen as froth regulators.

It has now been found that when adding a non-ionic surfactant to a N-acylated amino acid compound an improved recovery of the desired minerals such as phosphate minerals can be found and a more efficient froth flotation process can be performed, like at a lower collector dosage.

### BRIEF SUMMARY

This disclosure provides a collector composition suitable for treating non-sulfidic ores, the composition comprising:

(i) from about 1 to about 50 wt % of an N-acylated amino acid or salt thereof of the structural formula R1-CO—NX—CYH—(CH2)m-COOM
(ii) from about 10 to about 80 wt % of an alcohol alkoxylate of the formula R2-(AO)n wherein R1 is an alkyl or alkenyl group of about 7 to about 21 carbon atoms, X is a hydrogen atom or methyl group, Y is a hydrogen atom, a C1-C4 alkyl, a C1-C4 hydroxylalkyl, a C1-C4 carboxyalkyl, or a C1-C4 aminoalkyl group, m is 0 or 1, M is a proton, an alkalimetal cation, or a quaternary ammonium cation, R2 is an alkyl group of about 6 to about 20 carbon atoms, each AO is independently ethyleneoxy or propyleneoxy, provided that at least part of AO is ethyleneoxy, and n is greater than about 2 and up to about 25, the wt % being based on the total weight of the composition.

### DETAILED DESCRIPTION

The following detailed description is merely exemplary in nature and is not intended to limit the disclosure or the application and uses of the disclosure. Furthermore, there is no intention to be bound by any theory presented in the preceding background of the disclosure or the following detailed description.

Accordingly, the present disclosure provides a collector composition suitable for treating non-sulfidic ores comprising

(i) from about 1 to about 50 wt % of an N-acylated amino acid or salt thereof of the structural formula R1-CO—NX—CYH—(CH2)m-COOM
(ii) from about 10 to about 80 wt % of an alcohol alkoxylate of the formula R2-(AO)n wherein R1 is an alkyl or alkenyl group of about 7 to about 21 carbon atoms, X is a hydrogen atom or methyl group, Y is a hydrogen atom, a C1-C4 alkyl, a C1-C4 hydroxylalkyl, a C1-C4 carboxyalkyl, or a C1-C4 aminoalkyl group, m is 0 or 1, M is a proton, an alkalimetal cation or a quaternary ammonium cation, R2 is an alkyl group of about 6 to about 20 carbon atoms, each AO is independently ethyleneoxy or propyleneoxy, provided that at least part of AO is ethyleneoxy, and n is a number higher than about 2 and up to about 25, the wt % being based on the total weight of the composition.

It should be noted that alkyl and alkenyl groups are aliphatic groups and do not contain aromatic units in their structure (like aryl, aralkyl or alkaryl units would contain).

The present disclosure now acknowledges that adding alcohol alkoxylates in the proper amount to collector compositions that contain a N acylated amino acid improves the recovery of desired minerals and the efficiency of the flotation process in at least the sense that the collector composition can be dosed in a lower amount. Actually, the alcohol alkoxylate in a system based on N acylated amino acids functions as a secondary collector that has not been disclosed before.

Amongst others, the collector compositions and processes of the present disclosure provide unexpected good recovery at grades as generally strived for in the industry. For example, for treating phosphate ores, the industry is generally looking for grades between about 36 and about 40% P2O5, preferably from about 38 and about 40% P2O5, and trying to get an as high as possible recovery for these grades.

The compositions of the present disclosure are also exemplified by providing a well-balanced froth in the sense that the froth is stable and high enough to provide for a good flotation process but not so stable that particles get entrained or the several phases are hard to handle. Surprisingly, not only the presence of alcohol ethoxylates was found to play a role in the froth height and stability, and thereby the efficiency of the flotation process, especially when employed on a larger scale, but the simultaneous presence of compounds (i) and (ii) or so to say the balance between the two compounds.

In a preferred embodiment n is between about 3 and about 15, more preferably from about 4 and about 15, yet even more preferably between about 5 and about 12.

In embodiments of the present disclosure there can be two or more compounds (i) and/or (ii) in the collector composition. If two or more compounds (ii) are present in the collector composition, it is preferred if the average degree of alkoxylation is between about 4 and about 15.

As said the AO groups in compound (ii) can be purely ethyleneoxy (EO) groups but also a combination of ethyleneoxy (EO) units and propyleneoxy (PO) units. Preferably the amount of propyleneoxy units in compound (ii) is from about 0 to about 5% on total alkyleneoxy (AO) units.

The present disclosure also provides the use of the above collector composition in treating non sulfidic ores, preferably ores that contain phosphate and/or calcite minerals, even more preferably calcitic ores, and the process to treat non-sulfidic ores, preferably phosphate or calcite ores containing a flotation step in which ground ore is floated in the presence of the above collector composition.

In a preferred embodiment in the compound (i) m is 0.

As indicated, M can be hydrogen, an alkalimetal cation or a quaternary ammonium cation. Suitable quaternary ammonium cations are ammonium cations wherein the nitrogen atom contains 4 substituents that independently can be either alkyl groups of up to 3 carbon atoms or hydrogen atoms. Suitable alkalimetal cations are sodium and potassium.

In another preferred embodiment in the collector composition of the present disclosure in the compound (i) Y is hydrogen or a C1-C4 alkyl.

More preferably the unit NX—CYH—(CH2)m-COOM in the structural formula of compound (i) is derived from one of the amino acids glycine, sarcosine, alpha-alanine, beta-alanine, valine, leucine, isoleucine, most preferably from glycine or methylglycine, as glycinates were found to provide the best recovery and grade, even at low dosage.

In another preferred embodiment in the collector composition of the present disclosure in compound (ii) R2 is derived from about C10-C16 aliphatic alcohol R2-OH, and in yet another preferred embodiment the unit R2 has a degree of branching of between about 0.2 and about 3.5, even more preferably between about 0.5 and about 3.0, most preferably between about 1 and about 2.5. Even more preferably, R2 is derived from an alcohol R2-OH that contains at least about 50 wt % up to an including to about 100 wt % of primary alcohols, more preferably from about 90 to about 100 wt % of primary alcohols.

In yet another preferred embodiment in the collector composition of the present disclosure in compound (i) R1-CO— is from about C12-C18 acyl unit, and in yet another preferred embodiment R1 has a degree of branching of between about 0 and about 1. R1 is preferably an aliphatic alkyl or alkenyl chain. In embodiments R1 can be unsaturated, i.e. contain one or more double bonds. Preferably, the number of double bonds in the unit R1-CO— is from about 0 to about 3, even more preferably from about 1 to about 2. The R1-CO— group is in preferred embodiments derived from fatty acids such as they can be derived from natural fats and oils.

Preferably, the collector composition of the present disclosure contains from about 2 to about 40 wt % of compound (i) and from about 20 to about 80 wt % of compound (ii), even more preferably from about 5 to about 20 wt % of compound (i) and from about 30 to about 60 wt % of compound (ii).

In an alkyl group, such as R1 or R2, and similarly in an alkenyl group, the degree of branching is determined by adding up 2 for each carbon atom that is bound to 4 carbon atoms and 1 for all carbon atoms that are bound to three carbon atoms. For primary alkyl groups; by “the degree of branching” (DB) as used herein is meant the total number of (terminal) methyl groups present on the R1 and/or R2 alkyl (alkenyl) chain minus one (side chains that are alkyls other than methyls being counted by their terminal methyls). For secondary alkyl groups the same calculation can be used but the DB is the total number of methyl groups minus two. It should be noted that in this document the degree of branching is an average value for the alkyl groups R1 and R2 as present in the compound (i) and/or (ii) in the collector composition and hence does not have to be an integer. This is because many alcohols or fatty acids that can be used to provide the groups R1 and R2 are not pure compounds but exist as a mixture of several different compounds or isomers.

The collector composition of the present disclosure may in addition contain further components such as components selected from the group of fatty acids, alkyl benzene sulfonates, alkyl phosphates, alkyl sulfates, alkyl sulfosuccinamates, alkyl sulfosuccinates, alkyl lactylates, alkyl hydroxamates, surface active amphoteric components that can be chosen from the group of betaines, sulfobetaines, aminocarboxylates, aminosulfonates; nonionic components that can be chosen from the group of alkyl amides, alkoxylated fatty acids, preferably with a low degree of alkoxylation, even more preferably ethoxylated fatty acids with a low degree of ethoxylation, wherein low stands for 1 to 5 alkylene oxide, resp., ethylene oxide units, alkoxylated alcohols of the formula R3-(AO)n wherein n is up to and including 2, and R3 is a an (aliphatic) alkyl group as R2 and can be different or the same as R2 in compound (ii) and each AO is an alkoxylate, preferably an ethoxylate.

Preferred collector compositions of the present disclosure contain in addition from about 1 to about 70 wt %, preferably from about 15 to about 60 wt % of a secondary collector compound that is an anionic surface active compound such as those selected from the group of fatty acids, alkyl benzene sulfonates, alkyl phosphates, alkyl sulfates, alkyl sulfosuccinamates, alkyl sulfosuccinates, alkyl lactylates, and alkyl hydroxamates, for each anionic surface active compound, optionally containing alkoxylate groups, such as ethoxylate groups, on the alkyl group.

In another preferred embodiment the collector compositions of the present disclosure contain in addition from about 3 to about 50 wt %, preferably from about 5 to about 30 wt % of a fatty acid with up to 2 ethylene oxide units, and/or from about 1 to about 30 wt %, preferably from about 2 to about 25 wt % of an alcohol R3-(AO)n with up to 2 ethylene oxide units.

The process to treat ores as contemplated herein in an embodiment comprises the steps of:

conditioning, in an aqueous solution, a pulped mineral ore to form a mixture; optionally concentrating the mixture with magnetic separation;
optionally adding a frother to the mixture;
optionally conditioning the mixture with a flotation depressant or flotation activator; optionally adjusting the pH of the mixture;
adding the collector composition of the present disclosure;
optionally adding an additional flotation aid to the mixture; and
performing a froth flotation by introducing air into the mixture and skimming off froth formed therein to recover minerals.

The process and collector composition of the present disclosure may involve other additives and auxiliary materials which are typically present in a froth flotation process that can be added at the same time or, preferably, separately during the process. Further additives that may be present in the flotation process are depressants (such as starch, dextrin, quebracho), dispersants (such as water glass), frothers/froth regulators/froth modifiers/defoamers, and pH-regulators (such as NaOH).

The pH during the process is preferably an alkaline pH, even more preferably it is between about 8 and about 11.

In a preferred embodiment the process is a direct froth flotation process to recover phosphate minerals.

In another aspect, the present disclosure relates to a pulp comprising crushed and ground ore, a primary collector or a collector composition as defined herein, and optionally further flotation aids. This pulp can be prepared by first grounding the ore and then adding collector composition or by adding at least part of the collector composition to the ore and milling the ore to pulp in the presence of at least part of the collector composition.

The ores that can be used in the process of the present disclosure may include further minerals than phosphates and/or calcites. The mineral composition of most of the ore deposits throughout the world is generally similar, differing only in percentage of each mineral present according to their origin. Further minerals present in the ores may be different types of silicates, iron containing minerals, magnesium containing minerals and fluorite. Preferred phosphate ores are apatite ores.

The amount of the collector used in the process of the present disclosure will depend on the amount of impurities present in the ore and on the desired separation effect, but in some embodiments will be in the range of from about 100 to about 1000. g/ton dry ore, more preferably from about 150 to about 400 g/ton dry ore.

The present disclosure is illustrated by below examples

### EXAMPLES

General Flotation and Frothing Procedures

The flotation feed (500 g of dry matter) was milled in the ball mill (5 kg charge) during 5 min and deslimed.

The flotation was performed on the 1:1 blend of process water and fresh water at a temperature of 20 deg C., wherein the process water contained 25.6 mg/L of CaCl2*2H2O, 336.1 mg/L MgSO4*7H2O, 63.9 mg/l CaSO4*2H2O, 419.2 mg/L NaHCO₃, and 107.6 mg/L NaSO4.

The flotation procedure was as follows:

1. The pulp was mixed for 1 minute.
2. Soda was added to the flotation cell (400 g/t) and the further conditioning was taking place (3 min).
3. Water glass was added to the flotation cell (200 g/t) and the further conditioning was taking place (3 min).
4. Collector solution (as 1 wt % aqueous solution) was added at the same time and conditioned for 2 minutes.
5. The cell was filled up with flotation water to the marked level (37% solids).
6. Air and automatic froth skimmer were switched on at the same time.
7. The rougher flotation continued for 4 minutes. Water was added continuously to keep the right pulp level.
8. The collected froth of the rougher flotation was transferred to the 0.6 L flotation cell, filled with the prepared flotation water to the marked level and the cleaning of the froth was carried out for 3 min in the manner described in Nr 6&7 above.
9. The collected froth of the cleaning step of the flotation was transferred to the 0.3 L flotation cell, filled with the water to the marked level and the re-cleaning of the froth was carried out for 2 min in the manner described in Nr 6&7 above.
10. Tails, slime and concentrate obtained during rougher, cleaning and re-cleaning steps were collected, dried and analyzed for P2O5 and MgO content with XRF method.

TABLE 1
Flotation machine parameters
Twell flotation machine (pneumo-mechanical
laboratory flotation machines)

| Parameters | Rougher | Cleaning | Re-cleaning |
|---|---|---|---|
| Flotation time, min | 4 | 3 | 2 |
| Solids in pulp, % | 37.0 | 21.1-33.8 | 26.2-36.3 |
| Airflow, L/min | 2.5 | 2.5 | 0.5 |
| Scrape frequency (min-1) | 30 | 32 | 34 |

The feed for the frothing test (500 g of dry matter) was milled in the rod mill (6.2 kg charge) during 10 min. The pulp was placed into the cylindrical cell of the frothing machine and diluted up to 37% solids. The pulp was consequently conditioned with 200 g/t of sodium silicate (2 min), with 200 g/t of soda (2 min) and with the required dosage of collector (6 min). The frothing test was started by adding 3.5 L/min of air to the cell and the air was stopped after 300 sec in order to observe the height and stability of the froth formed.

Ore Compositions

Flotation ores:
Standard ore after magnetic separation (I)

### P2O5—9.6%, MgO—20.4%, SiO2—20.5%, Fe—3.2%

Standard ore after magnetic separation (II)

### P2O5—10.7%; MgO—17.0%, SiO2—24.5%, Fe—3.0%

Standard ore after magnetic separation (III)

### P2O5—12.1%, MgO—0.7%, SiO2—33.46%, Al2O3—15.05%, Fe—1.89%

### Example 1

Following the above process and employing the mentioned ore I a froth flotation process was performed using in the amounts as mentioned in Table 2 below as compound (i):

a tall oil based glycinate; and
as compound (ii):
a C13 alcohol ethoxylate having a degree of ethoxylation of about 10, made by reacting the C13 primary alcohol Exxal 13 ex Exxon Mobil having a DB of about 3.0 with 10 molar equivalents of ethylene oxide.

Further in the Examples a secondary collector that is a tall oil fatty acid was employed, a low ethoxylated tall oil fatty acid (degree of ethoxylation of about 1) as a selectivity improving additive and a low ethoxylated C13 alcohol (degree of ethoxylation of about 2 made by reacting Exxal 13 with 2 molar equivalents of ethylene oxide) as an additive to improve efficiency of the process.

TABLE 2
Comparison of several collector compositions

| | Tall oil | C13 | | | | |
|---|---|---|---|---|---|---|
| | acylated | alcohol + | | | | |
| | glycinate, | 10EO, | Tall oil | Tall oil | C13 | Recovery |
| Collector | Compound | Compound | fatty acid | fatty acid + | alcohol + | at 37% |
| composition* | (i), wt % | (ii) wt % | wt % | 1EO, wt % | 2EO, wt % | P2O5 |
| Comparative 1a | 0 | 27.3 | 54.4 | 0 | 18.3 | 82.6 |
| Invention 1b | 1.2 | 27.1 | 51.4 | 1.6 | 18.2 | 87.1 |
| Invention 1c | 3 | 27.3 | 46.1 | 4.1 | 18.3 | 85.9 |
| Invention 1d | 6 | 27.3 | 37.6 | 8.2 | 18.3 | 86.2 |
| Invention 1e | 9 | 27.3 | 29 | 12.3 | 18.3 | 87.9 |
| Invention 1f | 12 | 27.3 | 20.7 | 16.4 | 18.3 | 83.4 |
| Invention 1g | 8.3 | 25 | 51.8 | 11.3 | 0 | 88.1 |

*Remainder is aqueous solvent if not adding up to 100 wt %

The results show that when employing a combination of a compound (i) and a compound (ii) in the proper amounts, in this example a tall oil based N-acyl glycinate in combination with an ethoxylated C13 branched alcohol a much higher recovery (up to +5,3%) can be obtained. It is further demonstrated that adding an anionic surfactant as a further collector component further improves the recovery.

### Example 2

Following the above process and employing the mentioned ore II a froth flotation process was performed using

as compound (i):
a tall oil based glycinate as in Example 1 in the amount as mentioned in below Table 3; and
as compound (ii):
a highly ethoxylated 13 alcohol (degree of ethoxylation of about 10) as in Example 1 in the amount as indicated in below Table 3.

Furthermore a secondary collector that is a tall oil fatty acid was employed, as selectivity improving agent, in some of the Examples some tall oil fatty acid with a degree of ethoxylation of about 1 was added, and, as efficiency improving agent some ethoxylated C13 alcohol with a degree of ethoxylation of about 2.

TABLE 3
Comparison of several collector compositions

| | Tall oil | C13 | | | | | | |
|---|---|---|---|---|---|---|---|---|
| | acylated | alcohol + | | | | Grade | Recovery | Recovery |
| | glycinate, | 10EO, | Tall oil | Tall oil | C13 | of 2nd | of 2nd | at 37% |
| Collector | Compound | Compound | fatty acid | fatty acid + | alcohol + | concentrate, | concentrate, | P2O5, |
| composition* | (i), wt % | (ii) wt % | wt % | 1EO, wt % | 2EO, wt % | % | % | % |
| Comparative 2a | 22 | 0 | 38 | 30 | 0 | 24.3 | 86.7 | 48.6 |
| Comparative 2b | 0 | 26.7 | 46.6 | 0 | 26.7 | 35.3 | 81.5 | 76.4 |
| Invention 2c | 7.7 | 26.7 | 25.0 | 10.5 | 26.7 | 35.5 | 83.7 | 95.4 |

*Remainder is aqueous solvent if not adding up to 100%

The results clearly show that the use of only compound (ii) as contemplated herein results in poor recovery. The results furthermore demonstrate that the use of only compound (i) results in poor grade. The present disclosure provides the possibility to obtain both a good recovery and grade. The grade of the collector composition of the present disclosure is just below what the industry aims for, but the process can be optimized to get in this range by for example further adjusting the total amount of the collector composition and additives and finetuning the process parameters.

In Comparative Example 2a the froth formation was rather limited which made the flotation process suboptimal and in Comparative Examples 2b the froth was so stable that the process was harder to regulate. Hence, the balance between compounds (i) and (ii) was also found to be important to get a system that can be handled in a froth flotation process without additional steps as the foam has the right properties, such as a sufficient foam formation that is not so stable that the flotation process becomes impossible to regulate.

### Example 3

Following the above process and employing the mentioned ore III a froth flotation process was performed using

as compound (i):
a tall oil based glycinate as in Example 1 in the amount as mentioned in below Table 4; and
as compound (ii):
a highly ethoxylated 13 alcohol (degree of ethoxylation of about 10) as in Example 1 in the amount as indicated in below Table 4
as compound (iii) a highly ethoxylated (10 EO) C13 nonylphenol, prepared by reacting nonylphenol ex Sigma Aldrich with 10 molar equivalents of ethylene oxide was used in a parallel experiment for comparison.

Furthermore, a secondary collector that is a tall oil fatty acid was employed; as selectivity improving agent, some tall oil fatty acid with a degree of ethoxylation of about 1 was added.

In both the Comparative Example and the Example as contemplated herein the grade of the 2nd concentrate was in the desired range of from about 38 to 40%.

TABLE 4
Comparison of two collector compositions

| | Tall oil | C13 | | | C13 | |
|---|---|---|---|---|---|---|
| | acylated | alcohol + | | | nonylphenol + | |
| | glycinate, | 10.0EO, | Tall oil | Tall oil | 10.0EO, | Recovery |
| Collector | Compound | Compound | fatty acid | fatty acid + | Compound | of 2nd |
| composition* | (i), wt % | (ii) wt % | wt % | 1EO, wt % | (iii) wt % | concentrate, % |
| Comparative 3a | 10.0 | 0 | 15.2 | 10.8 | 60.0 | 88.8 |
| Invention 3b | 10.0 | 60.0 | 15.2 | 10.8 | 0 | 91.9 |

*Remainder is aqueous solvent if not adding up to 100%

The results show that the use of compound (ii) significantly improves the recovery comparing with the case where the ethoxylated nonylphenol compound (iii) is used for a grade that the industry prefers of between about 38 and 40%. The present disclosure provides the possibility to obtain excellent recovery and grade. Furthermore, replacing nonylphenolethoxylates with alkylethoxylates will enable better compliance with environmental regulations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. Collector composition suitable for treating non-sulfidic ores said composition comprising:
(i) from about 1 to about 50 wt % of an N-acylated amino acid or salt thereof of the structural formula R1-CO—NX—CYH—(CH2)m-COOM
(ii) from about 10 to about 80 wt % of an alcohol alkoxylate of the formula R2-(AO)n wherein R1 is an alkyl or alkenyl group of about 7 to about 21 carbon atoms, X is a hydrogen atom or methyl group, Y is a hydrogen atom, a C1-C4 alkyl, a C1-C4 hydroxylalkyl, a C1-C4 carboxyalkyl, or a C1-C4 aminoalkyl group, m is 0 or 1, M is a proton, an alkalimetal cation, or a quaternary ammonium cation, R2 is an alkyl group of about 6 to about 20 carbon atoms, each AO is independently ethyleneoxy or propyleneoxy, provided that at least part of AO is ethyleneoxy, and n is greater than about 2 and up to about 25, the wt % being based on the total weight of the composition.

2. Collector composition of claim 1 wherein Y is hydrogen or a C1-C4 alkyl.

3. Collector composition of claim 1 wherein R2 is derived from a C10-C16 aliphatic alcohol.

4. Collector composition of according to claim 1 wherein R2 has a degree of branching of from about 0.2 to about 3.5

5. Collector composition according to claim 1 wherein m is 0, X is hydrogen, Y is hydrogen or methyl.

6. Collector composition according to claim 1 comprising from about 5 to about 15 wt % of compound (i) and from about 30 to about 60 wt % of compound (ii), the wt % based on the total weight of the composition.

7. Collector composition of according to claim 1 wherein n is from about 4 to about 15.

8. Collector composition of according to claim 1 further comprising one or more components selected from the group of fatty acids, alkyl benzene sulfonates, alkyl phosphates, alkyl sulfates, alkyl sulfosuccinamates, alkyl sulfosuccinates, alkyl lactylates, alkyl hydroxamates, alkyl amides, betaines, sulfobetaines, aminocarboxylates, aminosulfonates, ethoxylated fatty acids, alkoxylated alcohols of the formula R3-(AO)n wherein n is up to and including 2.

9. Collector composition according to claim 1 further comprising from about 1 to about 70 wt % of a secondary collector compound that is an anionic surface active compound such as selected from the group of fatty acids, alkyl benzene sulfonates, alkyl phosphates, alkyl sulfates, alkyl sulfosuccinamates, alkyl sulfosuccinates, alkyl lactylates, and alkyl hydroxamates, the wt % based on the total weight of the composition.

10. Collector composition according to claim 1 further comprising from about 3 to about 50 wt % of a fatty acid with up to 2 ethylene oxide units, and/or from about 1 to about 30 wt % of an alcohol with up to 2 ethylene oxide units, the wt % being based on the total weight of the composition.

11. (canceled)

12. Process to treat non-sulfidic ores comprising a flotation step in which ground ore is floated in the presence of the collector composition according to claim 1.

13. Process of claim 12 further comprising the steps of:
conditioning, in an aqueous solution, a pulped mineral ore to form a mixture;
optionally concentrating the mixture with magnetic separation;
optionally adding a frother to the mixture;
optionally conditioning the mixture with a flotation depressant or flotation activator;
optionally adjusting the pH of the mixture;
adding the collector composition to the mixture;
optionally adding an additional flotation aid to the mixture; and
performing a froth flotation by introducing air into the mixture and skimming off froth formed therein to recover minerals.

14. Collector composition of claim 2 wherein R2 is derived from a C10-C16 aliphatic alcohol.

15. Collector composition of claim 2 wherein R2 has a degree of branching of from about 0.2 and about 3.5.

16. Collector composition of claim 3 wherein R2 has a degree of branching of from about 0.2 and about 3.5.

17. Process of claim 12 further comprising the steps of:
conditioning, in an aqueous solution, a pulped mineral ore to form a mixture;
concentrating the mixture with magnetic separation;
adding a frother to the mixture;
conditioning the mixture with a flotation depressant or flotation activator;
adjusting the pH of the mixture;
adding the collector composition to the mixture;
adding an additional flotation aid to the mixture; and
performing a froth flotation by introducing air into the mixture and skimming off froth formed therein to recover minerals.
